(19) United States
(12) Patent Application Publication
(10) Pub. No.: US 2026/0254658 A1
(43) Pub. Date: Aug. 27, 2026

(54) SYSTEM AND METHOD FOR REAL-TIME, ON-DEMAND ACCESS TO HUNTING LAND

(71) Applicant: Golden Ticket, LLC, Richville, MN (US)

(72) Inventors: Daniel Carlisle, Richville, MN (US); Allen Leo Schmitz, Wadena, MN (US); Charlie Krambeer, Rogers, MN (US)

(21) Appl. No.: 19/548,551

(22) Filed: Feb. 24, 2026

Related U.S. Application Data
(60) Provisional application No. 63/763,184, filed on Feb. 25, 2025.

(51) Int. Cl. H04L 9/32; G06Q 20/40

(52) U.S. Cl. CPC H04L 9/3247; G06Q 20/4014; H04L 9/3218

(57) ABSTRACT

A system for providing real-time, on-demand access to private hunting land, comprising: a mobile application configured to display a geospatial map overlay of available hunting land; a landowner portal that allows a landowner to dynamically update land access conditions for a property; a transaction processing module to facilitate electronic payments; an authentication module to verify credentials of a hunter and permit access to the property for an access period; and a liability waiver automation system that requires digital signatures before access is granted.

### CROSS-REFERENCE TO RELATED APPLICATIONS

This application claims the benefit of and priority to U.S. provisional application 63/763,184, titled “SYSTEM AND METHOD FOR REAL-TIME, ON-DEMAND ACCESS TO HUNTING LAND”, filed February 25, 2025, the contents of which are incorporated by reference herein.

### TECHNICAL FIELD

This patent document relates generally to electronic mapping and digital marketplace applications, and more particularly to systems and methods for facilitating access to land for hunting.

### BACKGROUND

Access to hunting land has become increasingly difficult because much of the United States is privately owned. Although a substantial share of that land is suitable for hunting, it remains largely inaccessible to hunters. Hunters often encounter difficulty in gaining and reserving access to land and water resources owned by other parties. In many cases, a sportsman must approach a landowner directly and in person to request access, and if the landowner is not present, the sportsman may be entirely unable to use the land even if willing to pay for such use. This direct, in-person contact may also discourage landowners from charging appropriate fees, even where the sportsman would willingly compensate the landowner.

Several approaches have been attempted to address these inefficiencies. For example, computerized reservation systems have been proposed that form networks of member hunters and member landowners, enabling hunters to browse available parcels, select properties, and make payments through a central processing unit. Such systems may allow landowners to list parcels with geographic identifications, usage availability, usage pricing, and property attributes such as terrain types, wildlife species, and facilities. Hunters may search a database of properties by various characteristics including geographic location, types of game, price, and availability. Rating and review mechanisms have also been proposed, where hunters rate parcels and landowners rate hunters based on attributes such as compliance with rules, courtesy, and respect for property.

Other approaches have focused on short-term leasing of private property on an hourly basis for events, meetings, outdoor gatherings, pet housing, and parking, utilizing mobile applications that allow property owners to list available spaces with photos, dimensions, pricing, and availability schedules. In the broader property rental space, systems have been developed that allow homeowners to list outdoor areas such as backyards, pools, patios, and decks for temporary rental, and that integrate service provider marketplaces connecting renters with event planners, photographers, musicians, caterers, and other vendors. Such systems employ recommendation modules using machine learning and artificial intelligence to match properties and service providers to renter profiles.

However, these existing systems suffer from several shortcomings when applied to hunting land access. First, existing reservation systems typically operate on a scheduled reservation model similar to vacation rental platforms, requiring advance booking, manual confirmation by landowners, and delayed communication between parties. This scheduled approach does not accommodate the spontaneous, real-time nature of hunting, where wildlife availability and weather conditions can change rapidly and where hunters may need immediate access to land without the delays inherent in traditional reservation workflows. Second, existing systems generally lack mandatory automated legal compliance mechanisms. While some systems contemplate optional waivers or terms and conditions, they do not enforce waiver completion as a technical prerequisite to access, leaving significant liability exposure gaps for landowners. Third, prior systems lack integration with government wildlife agency databases for real-time verification of hunting licenses and regulatory compliance, instead relying on self-reported hunter credentials that may be inaccurate, expired, or fraudulent. Fourth, existing property listing platforms do not integrate geospatial mapping with real-time land availability overlays that enable hunters to visually identify and immediately secure available properties in a geographic area. Fifth, prior art systems do not provide continuous location tracking, geofencing boundary alerts, or integrated emergency response capabilities that are critical safety features for remote hunting activities conducted on unfamiliar private land.

Accordingly, there remains a need in the art for a system and method that provides real-time, on-demand hunting land access with instantaneous transaction processing, mandatory automated liability waiver enforcement, integrated government database verification of hunter credentials, geospatial mapping with dynamic availability overlays, and comprehensive safety features including geofencing, continuous location tracking, and emergency response capabilities. There is also a need for such a system that enables landowners to dynamically control access conditions and pricing in real-time while reducing administrative burden, and that provides hunters with a seamless, mobile-first experience for discovering, securing, and navigating to available hunting land.

### SUMMARY

according to one aspect, provided is a system for providing real-time, on-demand access to private hunting land, comprising: a mobile application configured to display a geospatial map overlay of available hunting land; a landowner portal that allows a landowner to dynamically update land access conditions for a property; a transaction processing module to facilitate electronic payments; an authentication module to verify credentials of a hunter and permit access to the property for an access period; and a liability waiver automation system that requires digital signatures before access is granted.

According to another aspect there is a method for providing real-time access to hunting land, comprising: displaying, via a mobile application, a geospatial map overlay of available hunting land; receiving, via a landowner portal, dynamic updates of land access conditions; detecting a booking request from a hunter; withholding confirmation of a booking request until completion of: (a) verification of credentials of the hunter through the authentication module, (b) receipt and storage of an electronic signature of the hunter on a liability waiver through the liability waiver automation system, and (c) processing of an electronic payment through the transaction processing module; and subsequent to the withholding step, granting land access by generating a digital access permit.

According to a further aspect there is a non-transitory computer-readable storage medium storing instructions that, when executed by one or more processors, cause the one or more processors to: display, via a mobile application on a device of a hunter, a geospatial map overlay of available private hunting land, the geospatial map overlay reflecting real-time availability status of properties listed by one or more landowners; receive, via a landowner portal, access conditions and pricing information for a property from a landowner; receive a booking request from the hunter for the property; withhold confirmation of the booking request until completion of: (a) verification of credentials of the hunter through an authentication module, (b) receipt and storage of an electronic signature of the hunter on a liability waiver associated with the property, and (c) processing of an electronic payment through a transaction processing module; subsequent to completion of (a), (b), and (c), generate a digital access credential for the hunter authorizing access to the property for an access period; and transmit a notification to the landowner indicating that the hunter has been granted access to the property.

### BRIEF DESCRIPTION OF THE DRAWINGS

FIG. 1 is a system architecture diagram illustrating a cloud-based property access and booking system featuring a conditional liability waiver gate, in accordance with one embodiment of the present disclosure.

FIG. 2 is a flow diagram illustrating an exemplary method for facilitating temporary access to real property between a landowner and a hunter via a mobile application platform.

### DETAILED DESCRIPTION

By the present embodiments are provided a system and method for enabling real-time, on-demand access to private hunting land via a digital platform. This system can integrate a mobile application, landowner portal, transaction processing module, authentication mechanisms, and legal compliance automation to streamline and secure hunting access.

The present systems and methods allow landowners to dynamically list and manage their private land for hunting access while offering hunters instant verification and payment processing via a mobile application. This system can integrate interactive mapping, seamless transaction processing, and automated legal documentation handling, setting it apart from existing solutions. The real-time functionality can ensure that landowners can make their land available instantly while maintaining complete control over access terms and conditions. The systems and methods described may provide a relatively flexible system for landowners to financially benefit from their land while maintaining maximum control over the landowner’s property.

The system’s features can include real-time land availability updates, allowing landowners to toggle access/availability and modify hunting conditions in real-time. Hunters can search for and secure land access instantly through the mobile app, streamlining the process of finding hunting opportunities. Integrated payment processing can enable seamless transactions through various payment platforms such as Stripe, PayPal, Google Wallet, and Apple Pay, ensuring secure and immediate compensation to landowners. Additionally, the system can mandate that hunters sign digital liability waivers before securing access, protecting landowners from potential legal disputes. The mapping engine can overlay real-time land availability onto geographic databases, enabling hunters to view and select available properties quickly.

Thus, the present subject matter provides a system and method for enabling real-time, on-demand access to private hunting land via a digital platform. This system can integrate a mobile application, landowner portal, transaction processing module, authentication mechanisms, and legal compliance automation to streamline and secure hunting access.

This subject matter fundamentally changes the way hunters and landowners interact by offering a dynamic, real-time marketplace that maximizes land usage while ensuring regulatory compliance and security. Unlike traditional listing-based reservation systems, the present system eliminates delays in communication and manual confirmation, providing an efficient, automated solution for both parties.

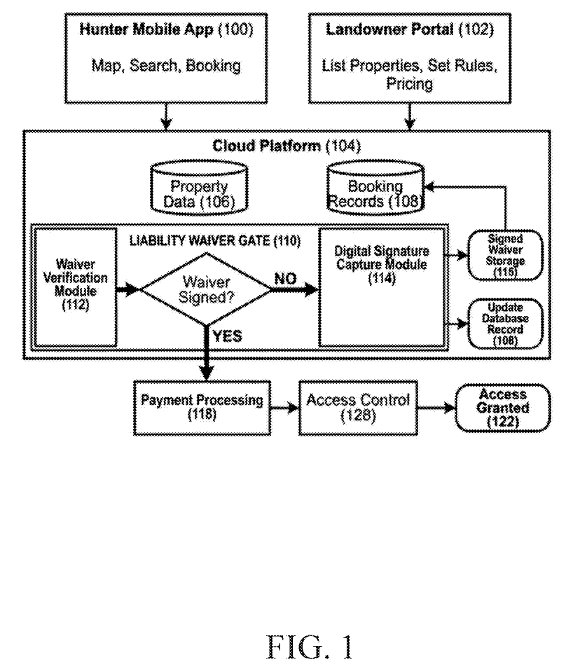

FIG. 1 is a system architecture diagram of the present system for providing real-time, on-demand access to private hunting land including a hunter mobile application (100), landowner portal (102), and cloud platform (104). The cloud platform maintains a property database (106) and booking records (108).

The liability waiver automation system (110) operates as a mandatory gate in the booking workflow. When a booking request is received, the system verifies whether a digital waiver has been signed. If not signed, the system blocks progression and activates the digital signature capture module (114). Only after signature verification does the system proceed to payment processing (118) and access control (120), ultimately granting access (122).

The liability waiver automation system (110) operates through a database-driven enforcement mechanism. Each booking request creates a database record with a waiver_verified field initially set to FALSE. The waiver verification module (112) queries this field before permitting workflow progression. If the field value is FALSE, the system generates an error state that prevents execution of the payment processing module (118). The system simultaneously activates the digital signature capture module (114), which retrieves the appropriate liability waiver template from storage, customizes it with property-specific terms and conditions, and presents it via the hunter mobile application (100).

The digital signature capture module (114) employs cryptographic timestamping to create a verifiable record of signature events. Upon signature completion, the module generates a unique transaction identifier, creates a digital fingerprint of the signed document to detect any subsequent tampering, and records both the digital fingerprint and timestamp in the signed waiver storage (115). The module then updates the database record, setting waiver_verified to TRUE and populating associated fields including signature_timestamp, document_identifier, and signer_ip_address. This database update triggers a workflow state change, enabling the booking management module to proceed to payment authorization.

The system enforces this gate condition through API-level access controls. The payment processing module (118) includes a pre-execution validation check that queries the waiver_verified field via a database API call. If the field returns FALSE or NULL, the payment authorization request is rejected with error code "WAIVER_INCOMPLETE" and no payment gateway communication occurs. If the field returns TRUE, the system proceeds with payment authorization. This architectural enforcement ensures that access cannot be granted through any workflow path—including error recovery, manual override, or administrative bypass—without verified waiver completion, distinguishing the system from optional waiver implementations that rely on user compliance rather than technical enforcement.

This architectural integration ensures no access can be granted without verified waiver completion, distinguishing the invention from prior art systems that treat waivers as optional features.

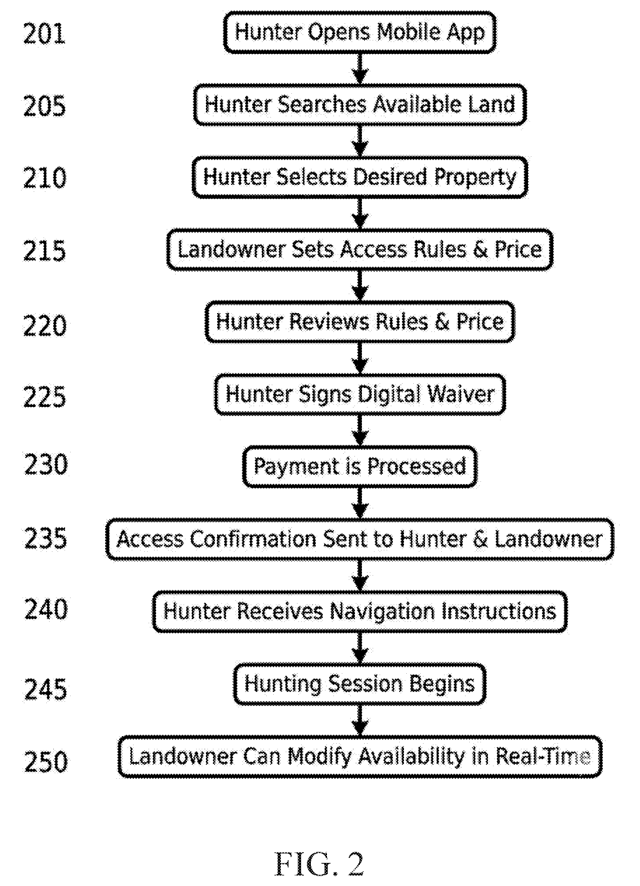

The operation of the mobile application is illustrated in FIG. 2. The mobile application 201 can serve as the user interface for hunters seeking land access. The application 201 can be configured to display a geospatial map overlay, integrating real-time data on available private hunting land. This overlay may be sourced from county and state land registry databases to ensure the most up-to-date property availability. The mobile application can provide a streamlined search function, allowing hunters to filter properties based on terrain, game species, proximity, and other landowner-defined criteria. Search results 205 may be weighted and sorted by various parameters including geographic proximity, price, availability, property ratings, types of game present, and property size. The mobile application may display detailed property information for each listed parcel, including satellite and topographical map imagery, property boundaries, photos and video descriptions of the property, descriptions of available facilities, terrain features, water access, trail locations, wildlife population estimates, rules of use, and pricing information. The mobile application may further provide navigation assistance, offering real-time route guidance from the hunter’s current location to designated property entry points. In some embodiments, the mobile application may include offline functionality, allowing hunters to download and store land information, maps, and navigation data for use in areas without reliable internet connectivity. The mobile application may also provide access to relevant hunting laws, regulations, rules, and licensing requirements for the jurisdiction in which a property is located, as well as weather and environmental condition forecasts for the property area.

The landowner portal 215 can function as an administrative interface for property owners, allowing them to dynamically manage land access conditions. Through this portal, landowners can set access conditions, including species constraints, time constraints, vehicle access, and maximum hunter limits. Additionally, landowners can receive real-time notifications when a hunter secures access and may remove availability instantaneously, ensuring full control over property use. The landowner portal may enable property owners to list one or more parcels by providing property identification numbers, addresses, or geographic coordinates, with the system querying county assessor or recorder databases to retrieve parcel boundaries, legal descriptions, verified acreage, and confirmed ownership information. Landowners may enter detailed property attributes including terrain types, water features, elevation, types of crops, types and estimated populations of wildlife, trail locations, access points, available facilities, and photos or video descriptions of the property and current conditions. The landowner portal may further enable property owners to manage pricing, utilizing either fixed rates for varying timeframes and numbers of hunters, tiered pricing based on demand or time of year, or dynamic pricing that adjusts automatically based on factors such as wildlife presence or recovery status since last hunting activity. The portal may include a scheduling module allowing landowners to set recurring access schedules, block dates for personal use, and manage seasonal availability. Landowners may also view activity reports listing past, current, and scheduled reservations, access codes issued to hunters, and financial transaction summaries. In some embodiments, the landowner portal may enable property owners to rate hunters based on attributes including compliance with property rules, cleanliness, courtesy, respect for boundaries, and accurate reporting of game harvested, with such ratings accessible to other landowners for informing future access decisions.

To verify access legitimacy, the system can include an authentication module that validates hunter credentials. This module may integrate with government and wildlife agencies to verify hunting licenses and compliance with state and federal hunting regulations. Additionally, hunters may receive digital proof of access 235, which can be verified by landowners or law enforcement officers. The authentication module may employ multi-factor verification, requiring the hunter to provide a state-issued sportsman identification number or hunting license number, which is then validated against government wildlife licensing authority databases (such as a state Department of Natural Resources or Game and Fish commission) through secure API connections. Upon successful verification, the system may retrieve the hunter’s full legal name, residential address, date of birth, physical description, and license validity status, caching this information locally in the hunter’s application profile for autofill functionality across subsequent bookings. The digital proof of access may comprise a time-limited digital pass displayed on the hunter’s mobile device, incorporating a QR code or alphanumeric access code that can be scanned or entered by landowners or law enforcement to confirm authorization. In some embodiments, the access code may serve as a passcode for opening a security gate or other physical access control device on the property. The system may implement periodic re-verification protocols, automatically querying government databases to detect license expirations, suspensions, or revocations, and preventing new booking requests when a hunter’s license status changes to invalid.

The system may include a hunter profile registration module that enables a hunter to establish a pre-configured profile prior to initiating any booking request. Through the mobile application, the hunter may enter and securely store personal identification information including a driver's license number, a photograph of the hunter's vehicle license plate, and one or more tokenized payment methods such as a credit card, debit card, or digital wallet account. The stored license plate image may be made available to the landowner and to law enforcement during an active access period to verify that a vehicle present on the property corresponds to an authorized hunter. The stored payment credentials enable the hunter to complete a booking transaction with a single confirmation input, eliminating manual re-entry of payment information and reducing the time required to complete a reservation from minutes to seconds. The hunter profile registration module operates in conjunction with the government wildlife agency database integration described herein, such that a hunter's pre-configured profile may combine hunter-provided information with agency-verified credential data to present a complete, verified hunter identity upon each booking request.

Before completing a booking, the system may present the hunter 220 with a consolidated access terms summary screen displaying the landowner's property-specific rules and conditions, including permitted species, allowed hunting methods, time-of-day restrictions, vehicle access limitations, maximum hunter capacity, designated entry and exit points, and any additional landowner-imposed requirements. This summary screen may also display the total access fee, broken down by base rate, any applicable surge or seasonal pricing adjustments, platform service fees, and optional add-ons such as liability insurance coverage. The hunter may be required to affirmatively acknowledge each category of rules and pricing before the system permits the booking to advance to the waiver signature and payment stages, ensuring that the hunter has reviewed and accepted the specific terms of access for that property. In some embodiments, the system may highlight terms that differ from the hunter's prior bookings on other properties, drawing attention to unusual or property-specific conditions the hunter may not have previously encountered.

The system further can include a liability waiver automation module, which can ensure that hunting access is granted only after a hunter has digitally signed a waiver or hold-harmless agreement. This module can store signed waivers for legal protection and regulatory compliance, providing an additional layer of security for landowners. Unlike prior art systems that treat liability waivers as optional features relying on user compliance, the present system enforces waiver completion as a mandatory technical gate condition within the booking workflow. The waiver automation module may retrieve property-specific waiver templates that incorporate terms and conditions defined by the landowner, applicable state-specific legal requirements, and standard hold-harmless provisions. The hunter reviews and electronically signs 220 the waiver through the mobile application, with the system capturing the digital signature, applying a cryptographic timestamp, and generating a unique document identifier for verification purposes. Both the signed document and its associated metadata may be stored in encrypted, tamper-evident storage, creating a legally defensible record of informed consent. The system may also allow hunters to apply for optional liability insurance through integrated insurance provider partnerships, enabling hunters to obtain coverage for personal injury, property damage, or third-party claims arising during the hunting access period. Similarly, landowners may apply for insurance protection through the system to cover claims made by hunters or other third parties.

The transaction processing module can enable secure payment handling. Once a hunter selects 210 a property, payment processing 230 can be facilitated through platforms such as Stripe, PayPal, Google Wallet, or Apple Pay. The module can be configured to automatically deposit funds into the landowner’s designated account upon successful booking. This can ensure a seamless, automated, and virtually instantaneous financial transaction between hunters and landowners. The transaction processing module may support multiple pricing models, including fixed daily rates, hourly access fees, tiered pricing based on demand or seasonality, and auction-based mechanisms where hunters may bid for access to high-demand properties. The module may also calculate and distribute payments, deducting platform service fees and remitting the balance to the landowner’s designated financial account. Payment methods may include credit cards, debit cards, digital wallets, and direct bank transfers. The system may generate itemized electronic receipts for both the hunter and the landowner, recording the transaction amount, property identifier, access duration, and applicable terms. In some embodiments, the module may support split payment functionality, allowing groups of two or more hunters to pay their respective portions of a shared booking independently. The transaction processing module may also manage refund processing, enabling landowners to issue full or partial refunds based on predefined cancellation policies, with automatic adjustment of financial records and availability status.

Upon completion of payment processing and waiver verification, the system may transition the booking status from confirmed to active, initiating the hunting access session 245. The system may transmit an access confirmation notification to both the hunter and the landowner, the notification including the authorized access window, applicable property rules, and a digital access credential. When the hunter arrives at the designated property entry point, the hunter may present the digital access credential displayed on the mobile application for verification by the landowner or, in some embodiments, for input into an automated access control device such as a security gate. Upon session activation, the system may automatically enable the continuous location tracking module and geofencing alert module for the duration of the access period, and the landowner portal may update to reflect the hunter's active presence on the property. The system may record a session start timestamp and begin logging the hunter's GPS position at regular intervals. Upon expiration of the authorized access window, the system may transmit a notification to the hunter indicating the session is ending and may transmit a departure confirmation request. If the hunter's tracked location remains within the property boundaries beyond a configurable grace period after session expiration, the system may notify the landowner of the continued presence.

The system can incorporate advanced safety and usability features, including:

Geofencing Alerts: The application can notify hunters when they approach restricted areas within a property with visual, audible, and haptic notifications that escalate in intensity as proximity to the boundary of the restricted area decreases, enhancing safety and compliance.

Navigation Assistance 240: The system can provide real-time routing to designated hunting locations, ensuring hunters arrive at the correct entry points.

Double-Booking Prevention: The availability of land parcels updates dynamically, preventing conflicts between multiple bookings.

Refund Processing: The mobile application can include a refund management module, allowing landowners to issue refunds based on predefined conditions.

Scheduling Module: Landowners may set recurring access schedules, block dates for personal use, instantaneously remove or reinstate land availability 250 and manage seasonal availability with ease.

Emergency Alert System: Hunters can send immediate distress notifications to authorities or landowners in the event of an accident.

Additional enhancements can include rating and reputation tracking, enabling hunters to review properties and landowners to assess hunter behavior. Following use of a property, hunters may rate the parcel based on parameters including overall quality of experience, abundance of game, accuracy of property descriptions, ease of access, quality of facilities, courtesy of landowners, and compliance with posted rules. Ratings may include numerical scores as well as free-form text reviews. Similarly, landowners may rate hunters based on attributes such as cleanliness, compliance with property rules and hunting regulations, courtesy, respect for property boundaries, and timely departure. These bidirectional ratings may be stored, averaged, and displayed within the system to inform future access decisions. In some embodiments, landowners may restrict access to their properties to hunters meeting a minimum rating threshold, and hunters with consistently low ratings may be automatically blocked from making new reservations. Rating information may be kept private for the rater’s own use, shared only with other landowners, or made publicly available to all system participants. The system may also integrate with insurance providers to offer optional liability coverage for both hunters and landowners, further reducing financial risk.

In some embodiments, the system may include offline functionality, allowing hunters to store land information and access navigation tools without internet connectivity. Additionally, artificial intelligence modules can suggest optimal hunting locations based on user preferences, historical data, and real-time availability.

In some examples, the system may implement a bidding feature that enables hunters to bid for access to one or more particular properties. In some examples, the system may present a user with potential properties to access indicating how recently the properties have been occupied, for example by color changes that correspond to a time since the property has been occupied for hunting. For example, a property may be initially shown in red color while currently occupied for hunting and/or for a first time period after the property has been occupied, transition to being shown in a yellow color a second time period after the property has been occupied, and transition to a green color a third time period after the property has been occupied. In some examples, the first, second, and third time period may be selected to correspond to a predetermined time for animals to naturally return to the property after it was previously occupied for hunting. In some examples, pricing to occupy a property may depend on how recently the properties have been occupied (e.g., whether in the first, second, or third time period).

The present subject matter offers an innovative approach to accessing private hunting land, addressing key challenges faced by both hunters and landowners. By automating access control, payment processing, legal compliance, and safety measures, this system creates a seamless, efficient, and secure platform for hunting access transactions.

This subject matter may provide several advantages over traditional hunting access methods. First, the ability to process transactions instantaneously allows hunters to gain access without the delays associated with manual negotiations or reservation approvals. Second, landowners benefit from dynamic land control, ensuring that they can adjust access conditions based on seasonal changes, personal use, or regulatory updates. Third, enhanced security and compliance measures protect both hunters and landowners by verifying user identities, enforcing property rules, and logging all transactions for future reference, especially for regulatory compliance and security tracking. Additionally, the system may optimize land utilization by allowing landowners to monetize otherwise unused property on a flexible, on-demand basis.

Possible alternative implementations include a subscription-based payment model that could be introduced as an alternative to one-time payments, offering hunters unlimited seasonal access for a fixed fee. A hybrid approval system could also be implemented, where landowners manually approve access requests while still benefiting from automated transactions and legal compliance. Furthermore, the system could integrate with wearable GPS-enabled hunting devices, offering real-time location tracking and boundary alerts for enhanced safety.

The methods and systems described herein may be implemented using one or more processors executing instructions stored on a non-transitory computer-readable storage medium. The mobile application, landowner portal, and cloud platform modules may each comprise software instructions stored in memory and executed by one or more processors to perform the functions described.

The system may further include the following additional functional modules that enhance the platform's capabilities for both hunters and landowners.

### Real-time game alert notification system

The system may include a real-time game alert notification module that enables landowners to broadcast time-sensitive wildlife sighting information to hunters. When a landowner observes wildlife activity on their property (e.g., migrating waterfowl, deer herds, elk), the landowner portal (102) provides an alert creation interface allowing the landowner to upload photographic evidence, specify wildlife species, and estimate population count.

Upon alert creation, the system captures GPS coordinates from the photo metadata, applies a cryptographic timestamp, and associates the alert with the specific property parcel. The system automatically sets an expiration timer (configurable, default 24 hours) after which the alert is removed from active display, preventing distribution of stale or misleading information about wildlife presence.

The hunter mobile application (100) includes a notification preference module allowing hunters to configure geographic radius filters (e.g., alerts only within 50 miles of current location) and species-specific filters (waterfowl only, big game only). When a game alert matching the hunter's filter criteria is posted, the system generates a push notification to the hunter's device and displays the alert on the geospatial map overlay with a distinctive visual indicator (e.g., flashing icon, highlighted parcel).

The game alert system integrates with the dynamic pricing module, allowing landowners to implement temporary price adjustments based on current wildlife presence. For example, upon posting a game alert, the landowner can increase the access fee from a base rate to a premium rate, with the price automatically reverting to the base rate upon alert expiration. This creates an economically rational mechanism for landowners to capitalize on transient wildlife concentrations while providing hunters with verified, time-sensitive hunting opportunities.

The system maintains an alert verification log recording the timestamp of alert creation, photo verification data, GPS coordinates, species identified, and pricing changes, creating an audit trail that discourages fraudulent or misleading alerts.

### Continuous hunter location tracking with emergency response

The system may include a continuous location tracking module distinct from the geofencing alert system. While the geofencing module generates boundary proximity alerts, the continuous tracking module maintains a persistent GPS location log throughout the hunter's access period, recording position coordinates at regular intervals (e.g., every 30 seconds or upon significant position change).

The tracking data serves multiple functions. First, it enables the landowner portal (102) to display real-time hunter location on a property map overlay, allowing landowners to verify that hunters remain within authorized boundaries and do not stray onto restricted parcels or neighboring properties. The system generates landowner alerts if a hunter's tracked position enters a geofenced exclusion zone, providing immediate notification of potential trespass.

Second, the location tracking system provides critical emergency response capability. If a hunter activates an emergency distress signal through the mobile application (100), the system automatically transmits the hunter's current GPS coordinates and recent location history to emergency services and the landowner. The location history includes timestamps and positional data for the preceding time period (e.g., last 4 hours), enabling first responders to determine the hunter's trajectory and locate the individual even if they have moved or become incapacitated since activating the alert.

The system maintains location data in encrypted storage for the duration of the access period plus a retention period (e.g., 24 hours post-access) for liability protection purposes, then automatically purges the data. Hunters receive notification that location tracking is active and may disable tracking functionality, though doing so triggers a warning that emergency response capability will be degraded.

Location data is accessible only to: (1) the hunter, (2) the landowner for the specific property being accessed, (3) emergency services upon distress signal activation, and (4) law enforcement with proper authorization. The system implements role-based access controls preventing unauthorized access to hunter location data.

### Enhanced authentication with government wildlife agency database integration

The authentication module may be configured to integrate with state government wildlife licensing authority databases (for example, a state Department of Natural Resources, Game and Fish commission, or equivalent agency) through secure API connections. Upon initial user registration, the hunter provides their state-issued sportsman identification number or hunting license number. The system queries the applicable government wildlife agency database via API, retrieving verified hunter information including full legal name, residential address, date of birth, physical description, and license validity status.

This government database integration provides dual functionality. First, it enables automated license verification, confirming that the hunter possesses a valid, current hunting license before permitting access reservation. Second, it enables form autofill functionality across multiple property bookings. After initial verification, the hunter's validated credential data is cached locally in the hunter's application profile. When the hunter initiates a booking at a new property, the system automatically populates required registration fields (name, address, license number, etc.) without requiring manual re-entry, significantly reducing friction for hunters accessing multiple properties.

For landowners, similar integration may be provided with county assessor or recorder databases. Upon property registration, the landowner provides parcel identification numbers. The system queries county databases to retrieve parcel boundaries, legal descriptions, acreage, and verified ownership information, automatically populating property listing fields and confirming the landowner's legal authority to grant hunting access.

The system implements data synchronization protocols, periodically re-querying government wildlife agency databases to detect license expirations, suspensions, or revocations. If a hunter's license status changes to invalid, the system automatically prevents new booking requests and may notify the hunter to update their credentials.

All database queries are conducted over encrypted connections, with API keys securely stored and rotated periodically. The system logs all database access events for security auditing purposes.

### Combined system benefits

The integration of real-time game alerts, continuous hunter location tracking, and government wildlife agency database authentication into a unified platform produces compounding benefits that individual features alone cannot achieve. The game alert system creates a feedback loop between landowners and hunters: landowners are incentivized to actively monitor and report wildlife activity because verified alerts drive increased bookings at premium pricing, while hunters gain access to time-sensitive, photographic-evidence-backed wildlife sighting data that enables informed decisions about where to hunt. This bidirectional information exchange transforms the platform from a passive reservation system into an active hunting intelligence network.

The combination of continuous location tracking with the geofencing boundary system provides layered safety and liability coverage: geofencing delivers immediate boundary violation alerts, while the persistent GPS log creates a complete historical record of hunter movement throughout the access period. In an emergency, first responders receive not merely a single GPS coordinate but a trajectory history that significantly improves search-and-rescue effectiveness in rural and wilderness settings. For landowners, the location tracking log provides objective evidence of hunter compliance with property boundaries and access terms, reducing disputes and supporting insurance claims.

The government wildlife agency database integration eliminates a category of fraud risk that cannot be addressed through self-reported credentials alone. By programmatically verifying license validity, species endorsements, and regulatory standing directly with state wildlife licensing authorities, the system prevents unlicensed individuals from booking access and protects landowners from potential legal exposure associated with facilitating unauthorized hunting activity. The autofill functionality built on verified agency data simultaneously reduces booking friction, enabling hunters to complete reservations across multiple properties without redundant manual data entry, while ensuring that every booking is backed by current, agency-verified credentials rather than stale or fabricated information.

The mandatory automated waiver enforcement provides additional advantages over optional waiver systems. Optional waiver approaches achieve limited voluntary completion rates among users, creating significant liability exposure gaps for property owners. In contrast, the present system's architectural enforcement achieves complete legal compliance by preventing any booking confirmation or access grant without verified waiver completion. This technical integration of legal compliance into access control logic ensures complete liability protection without relying on user diligence or manual verification processes. The cryptographic timestamping and immutable audit trail create legally defensible proof of agreement that surpasses the evidentiary value of paper-based or optionally-signed electronic waivers, particularly in jurisdictions requiring strict proof of informed consent.

### Examples

The following claim examples are hereby incorporated into the Detailed Description, with each example standing on its own as a separate embodiment.

In Example 1, a system for providing real-time, on-demand access to private hunting land may comprise a mobile application configured to display a geospatial map overlay of available hunting land, a landowner portal that allows landowners to dynamically update land access conditions, a transaction processing module to facilitate electronic payments, an authentication module to verify hunter credentials and permit access, and a liability waiver automation system that requires digital signatures before access is granted. The geospatial map overlay may integrate with county and state land registry databases, ensuring up-to-date land availability. The landowner portal may allow landowners to specify hunting conditions, such as time constraints, vehicle access, and maximum hunter limits.

In Example 2, the system of Example 1 may further comprise a feature where hunters receive digital proof of access, which can be verified by law enforcement or landowners. The transaction processing module may automatically deposit funds into landowner accounts upon successful booking. Additionally, the landowner portal may allow instantaneous removal/reinstatement of land availability.

In Example 3, the system of Example 2 may further include a geofencing feature that alerts hunters when they approach restricted areas. Hunting access may be granted only after completion of a digital liability waiver. Landowners may receive real-time notifications when a hunter secures access to their land.

In Example 4, the system of Example 3 may include a navigation feature where the mobile application provides route guidance to the designated hunting location. The system may prevent double-booking through real-time availability updates.

In Example 5, the system of Example 4 may further comprise a refund policy managed through the mobile application, allowing landowners to issue refunds under predefined conditions. The system may also record access logs for regulatory compliance and security tracking.

In Example 6, the system of Example 5 may enable hunters to filter available lands based on terrain type, game species, proximity, and specific landowner criteria. The system may also facilitate multi-party bookings for hunting groups.

In Example 7, the system of Example 6 may provide an interface for landowners to set tiered pricing based on demand, time of year, or specific hunting conditions.

In Example 8, the system of Example 7 may integrate with government and wildlife agencies to validate hunter licenses and compliance with hunting regulations.

In Example 9, the system of Example 8 may enable hunters to rate their experience on a particular property, allowing for reputation-based property listings.

In Example 10, the system of Example 9 may include a scheduling module where landowners can set recurring access schedules and block out dates for personal use.

In Example 11, the system of Example 10 may further include a feature for emergency alerts, allowing hunters to notify authorities or landowners in case of an accident or emergency.

In Example 12, the system of Example 11 may include a security module that validates user identity through biometric authentication before granting access to property.

In Example 13, the system of Example 12 may provide an AI-based recommendation engine that suggests optimal hunting locations based on user preferences and historical data.

In Example 14, the system of Example 13 may integrate with weather tracking services to provide hunters with real-time environmental conditions and forecasts.

In Example 15, the system of Example 14 may include offline functionality, allowing hunters to access land information and navigation even in areas without internet coverage.

In Example 16, the system of Example 15 may enable landowners to communicate directly with hunters through an integrated messaging system.

In Example 17, the system of Example 16 may enable landowners to provide game alerts to hunters in real-time indicating that animals are available to hunt on a property.

In Example 18, the system of Example 16 may incorporate drone surveillance capabilities to allow landowners to remotely monitor their property during active hunting periods.

In Example 19, the system of Example 18 may allow for corporate and group licensing options, permitting multiple hunters under a single account or transaction.

In Example 20, the system of Example 19 may include multilingual support, allowing non-English speaking hunters to access property listings and communicate with landowners.

In Example 21, the system of Example 20 may integrate with insurance providers to offer optional liability insurance for hunters and landowners during transactions.

In Example 22, the system of Example 21 may further include a real-time game alert notification module, wherein a landowner uploads photographic evidence of wildlife activity through the landowner portal along with species identification and estimated population count. The system may capture GPS coordinates from the photo metadata, apply a cryptographic timestamp, and associate the alert with the specific property parcel. The system may automatically set a configurable expiration timer after which the alert is removed from active display to prevent distribution of stale wildlife information. The hunter mobile application may include a notification preference module allowing hunters to configure geographic radius filters and species-specific filters, such that when a game alert matching the hunter's filter criteria is posted, the system generates a push notification and displays the alert on the geospatial map overlay with a distinctive visual indicator. The game alert system may further integrate with the dynamic pricing module, allowing landowners to implement temporary price adjustments based on current wildlife presence, with the price automatically reverting to a base rate upon alert expiration. The system may maintain an alert verification log recording the timestamp of alert creation, photo verification data, GPS coordinates, species identified, and pricing changes.

In Example 23, the system of Example 22 may further include a continuous location tracking module that maintains a persistent GPS location log throughout the hunter's access period, recording position coordinates at regular intervals or upon significant position change. The landowner portal may display real-time hunter location on a property map overlay, and the system may generate landowner alerts if recorded GPS coordinates of the hunter indicate the hunters has entered a geofenced exclusion zone. The continuous location tracking system may further provide emergency response capability, wherein upon activation of an emergency distress signal by the hunter through the mobile application, the system automatically transmits the hunter's current GPS coordinates and recent location history to emergency services and the landowner, the location history including timestamps and positional data enabling first responders to determine the hunter's trajectory. The system may maintain location data in encrypted storage for the duration of the access period plus a configurable retention period, then automatically purge the data. Location data may be accessible only to the hunter, the landowner for the specific property being accessed, emergency services upon distress signal activation, and law enforcement with proper authorization, with role-based access controls preventing unauthorized access.

In Example 24, the system of Example 23 may further include authentication module integration with governmental wildlife licensing authority databases (such as a Department of Natural Resources or Game and Fish commission) through secure API connections. Upon initial user registration, the hunter may provide a state-issued sportsman identification number or hunting license number, and the system may query the government wildlife agency database via API to retrieve verified hunter information including full legal name, residential address, date of birth, physical description, and license validity status. The verified credential data may be cached locally in the hunter's application profile, enabling form autofill functionality across multiple property bookings such that the system automatically populates required registration fields without requiring manual re-entry. The system may implement data synchronization protocols that periodically re-query government wildlife agency databases to detect license expirations, suspensions, or revocations, and upon detecting an invalid license status, the system may automatically prevent new booking requests. For landowners, the system may integrate with county assessor or recorder databases to retrieve parcel boundaries, legal descriptions, acreage, and verified ownership information upon property registration using parcel identification numbers.

While exemplary embodiments have been disclosed, it will be understood by those skilled in the art that various changes may be made and equivalents may be substituted for elements thereof without departing from the scope of the embodiments. In addition, many modifications may be made to adapt a particular situation or material to the teachings of the invention without departing from the essential scope thereof. Therefore, it is intended that the invention is not limited to the particular embodiment(s) disclosed, but that the invention will include all embodiments falling within the scope of the appended claims.

What is claimed is:

1. A system for providing real-time, on-demand access to private hunting land, comprising:
a mobile application configured to display a geospatial map overlay of available hunting land;
a landowner portal that allows a landowner to dynamically update land access conditions for a property;
a transaction processing module to facilitate electronic payments;
an authentication module to verify credentials of a hunter and permit access to the property for an access period; and
a liability waiver automation system that requires digital signatures before access is granted.

2. The system of claim 1, wherein the system is configured to send a hunter digital proof of access that can be verified by law enforcement or landowners.

3. The system of claim 1, further comprising: a real-time geofencing module that continuously monitors hunter GPS location during the access period and automatically generates boundary alerts when the hunter approaches within a predefined distance of property boundaries or restricted zones, wherein the boundary alerts comprise visual, audible, and haptic notifications that escalate in intensity as proximity to the boundary decreases.

4. The system of claim 1, further comprising: filtering capabilities that allow hunters to search available lands based on terrain type, game species, proximity, and landowner-defined criteria.

5. The system of claim 1, further comprising: an interface for landowners to set tiered pricing based on demand, time of year, or specific hunting conditions.

6. The system of claim 1, further comprising: a rating system that enables hunters to rate their experience on a particular property, facilitating reputation-based property listings.

7. The system of claim 1, further comprising: a wildlife recovery status module configured to calculate a recovery metric for each property based on time elapsed since last hunting activity, wherein the mobile application displays properties with visual indicators corresponding to calculated recovery status, and wherein access pricing automatically adjusts based on the recovery metric.

8. The system of claim 1, wherein the liability waiver automation system prevents the payment processing module from executing until digital signature verification is confirmed.

9. The system of claim 1, further comprising: a real-time game alert module configured to enable landowners to post wildlife sighting notifications with photographic evidence, wherein each alert includes: (a) a cryptographic timestamp, (b) GPS coordinates extracted from photo metadata, (c) an automatically-set expiration timer that removes the alert from display after a predetermined time period, (d) species identification metadata, and (e) integration with dynamic pricing controls that allow temporary price adjustments triggered by wildlife presence, wherein hunters receive push notifications for alerts matching pre-configured geographic radius and species filters.

10. The system of claim 1, further comprising: a continuous location tracking module configured to record GPS position coordinates of the hunter at regular intervals throughout the access period, wherein the tracking module: (a) maintains a location history log accessible to the landowner for verifying compliance by the hunter with property boundaries, (b) automatically transmits current coordinates and a recent location history to emergency services upon activation of a distress signal by the hunter, (c) generates alerts to the landowner when recorded GPS coordinates of the hunter indicate the hunter has entered a geofenced exclusion zone, and (d) implements role-based access controls limiting location data access to authorized parties only, with automatic data purging after a predetermined retention period.

11. The system of claim 1, wherein the authentication module is configured to integrate with a government wildlife licensing authority databases via a secure API connection, retrieve verified hunter information including name, address, and license validity status using a state-issued sportsman identification number, cache the retrieved information in an application profile associated with the hunter, and automatically populate registration fields for subsequent property bookings without requiring manual re-entry by the hunter.

12. A method for providing real-time access to hunting land, comprising:
displaying, via a mobile application, a geospatial map overlay of available hunting land;
receiving, via a landowner portal, one or more updates to access conditions for a property;
receiving a booking request from a hunter for the property;
withholding confirmation of the booking request until completion of: (a) verification of credentials of the hunter through an authentication module, (b) receipt and storage of an electronic signature of the hunter on a liability waiver associated with the property, and (c) processing of an electronic payment through a transaction processing module; and
upon completion of (a), (b), and (c), granting access to the property by generating a digital access credential for the hunter.

13. The method of claim 12, further comprising: providing navigation guidance to designated hunting locations through the mobile application; and preventing double-booking through real-time availability updates.

14. The method of claim 12, further comprising: activating a continuous location tracking module upon initiation of an access period, the continuous location tracking module recording GPS coordinates of the hunter at regular intervals; and transmitting the GPS coordinates and a location history to emergency services upon activation of a distress signal by the hunter.

15. The method of claim 12, further comprising: receiving from the landowner, via the landowner portal, a game alert comprising photographic evidence of wildlife activity on the property; and transmitting a notification of the game alert to the hunter when the game alert matches geographic and species filter preferences configured by the hunter.

16. A non-transitory computer-readable storage medium storing instructions that, when executed by one or more processors, cause the one or more processors to:
display, via a mobile application on a device of a hunter, a geospatial map overlay of available private hunting land, the geospatial map overlay reflecting real-time availability status of properties listed by one or more landowners;
receive, via a landowner portal, access conditions and pricing information for a property from a landowner;
receive a booking request from the hunter for the property; and
withholding confirmation of the booking request until completion of: (a) verification of credentials of the hunter through an authentication module, (b) receipt and storage of an electronic signature of the hunter on a liability waiver associated with the property, and (c) processing of an electronic payment through a transaction processing module; subsequent to completion of (a), (b), and (c), generate a digital access credential for the hunter authorizing access to the property for an access period; and transmit a notification to the landowner indicating that the hunter has been granted access to the property.

17. The non-transitory computer-readable storage medium of claim 16, wherein the instructions further cause the one or more processors to retrieve a property-specific waiver template incorporating terms defined by the landowner and legal requirements of a jurisdiction in which the property is located, and to prevent processing of the electronic payment until the electronic signature on the liability waiver has been verified and stored.

18. The non-transitory computer-readable storage medium of claim 16, wherein the instructions further cause the one or more processors to query a government wildlife licensing authority database to verify a hunting license associated with the hunter, and to cache verified hunter information in an application profile associated with the hunter for automatic population of registration fields in subsequent booking requests.

19. The non-transitory computer-readable storage medium of claim 16, wherein the instructions further cause the one or more processors to activate a continuous location tracking module upon initiation of the access period, the continuous location tracking module recording GPS coordinates of the hunter at regular intervals and transmitting the GPS coordinates and a location history to emergency services upon activation of a distress signal by the hunter.

20. The non-transitory computer-readable storage medium of claim 16, wherein the instructions further cause the one or more processors to receive from the landowner, via the landowner portal, a game alert comprising photographic evidence of wildlife activity on the property, and to transmit a notification of the game alert to the hunter when the game alert matches geographic and species filter preferences configured by the hunter.
